(19) United States
(12) Patent Application Publication
(10) Pub. No.: US 2022/0025655 A1
(43) Pub. Date: Jan. 27, 2022

(54) DOOR MAT

(71) Applicant: Homecare Products, Inc., Algona, WA (US)

(72) Inventor: Donald Everard, Maple Valley, WA (US)

(21) Appl. No.: 17/384,633

(22) Filed: Jul. 23, 2021

Related U.S. Application Data
(60) Provisional application No. 63/056,455, filed on Jul. 24, 2020.

(51) Int. Cl. E04F 11/00; A47L 23/26; A47G 27/02; G09F 23/00

(52) U.S. Cl. CPC E04F 11/002; G09F 23/00; A47G 27/0243; A47L 23/266

(57) ABSTRACT

A door mat includes a body having an inclined top surface and a visual indicator defined in the inclined top surface having a first visual appearance from a first view of the door mat and a second visual appearance from a second view of the door mat.

### CROSS-REFERENCE TO RELATED APPLICATIONS

This application claims the benefit of U.S. Provisional Patent Application No. 63/056,455, filed Jul. 24, 2020, the disclosures of which are hereby expressly incorporated by reference herein.

### BACKGROUND

Ramps are typically used to provide easy access between a first level and a second higher level to those who are physically challenged, such as those confined to wheelchairs or other wheeled mobility devices. A threshold ramp is a specialized ramp that defines a gradual incline to a raised surface. Often a threshold ramp is used to define a gradual transition to a threshold of a door, which is the sloped crosspiece that extends across the bottom of the doorway. The threshold is slightly raised off the ground to keep water from flowing in. A threshold ramp may also be used to define a gradual transition to a small step or another obstacle (hereinafter collectively referred to as a “threshold”).

By defining a gradual slope to the threshold, a threshold ramp enables a wheeled mobility device to easily roll across the threshold. The threshold ramp may also be helpful for someone that “shuffle steps”. More specifically, a threshold ramp defines a gentle slope that may help reduce the risk of tripping and falling when someone shuffles over the threshold.

A threshold ramp may be configured as a wedge-shaped section of heavy-duty aluminum or rubber that sits adjacent to and beneath a threshold. A threshold ramp can be permanent, semi-permanent or portable. In a residential setting, the home owner may choose to include a threshold ramp adjacent to and beneath the front door like a door mat to provide easy entry access to the homeowner and visitors.

Embodiments of the present disclosure are directed to an improved threshold ramp.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a door mat includes a body having an inclined top surface and a visual indicator defined in the inclined top surface having a first visual appearance from a first view of the door mat and a second visual appearance from a second view of the door mat.

In another aspect, a door mat includes a body having an inclined top surface and a visual indicator defined in the inclined top surface having an original visual appearance from a top view of the door mat and a distorted visual appearance from a front view of the door mat.

In another aspect, a door mat includes a body having an inclined top surface and a visual indicator defined on the inclined top surface having a first visual appearance from a first view of the door mat and a second visual appearance from a second view of the door mat.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is an environmental view of an exemplary embodiment of a door mat shown in use with a doorway;

FIG. 2 is an isometric view of the door mat of FIG. 1;

FIG. 3 is a top view of the door mat of FIG. 1;

FIG. 4 is a side view of the door mat of FIG. 1; and

FIG. 5 is a front view of the door mat of FIG. 1.

### DETAILED DESCRIPTION

As noted above, a threshold ramp may be configured as a wedge-shaped section of heavy-duty aluminum or rubber that sits adjacent to and beneath a threshold. In a residential setting, the home owner may choose to include a threshold ramp adjacent to and beneath the front door like a door mat to provide easy entry access to the homeowner and visitors.

However, if someone is not accustomed to using a threshold ramp, the threshold ramp may actually increase that person's risk of tripping and falling over the threshold. For instance, a person walking towards a door naturally waits until reaching the door threshold before stepping on or over it. A threshold ramp, which inclines the walking surface before reaching the threshold, may actually cause the person to trip if not paying close attention.

Embodiments of the present disclosure are directed to an improved threshold ramp that may be used as a door mat and that helps reduce the risk of tripping and falling for unaccustomed users.

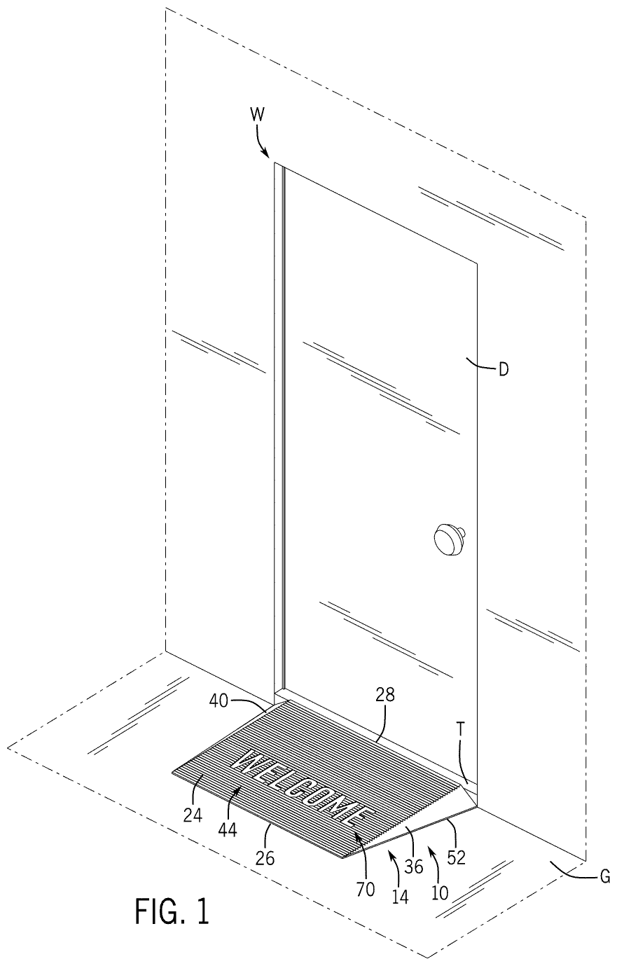

Referring to FIG. 1, a door mat 10 formed in accordance with an exemplary embodiment of the present disclosure is depicted. The door mat 10 is shown positioned adjacent to and beneath a door D of a doorway W. In that regard, the door mat 10 generally acts as a threshold ramp that provides an inclined surface from the ground G to the threshold T. However, it should be appreciated that the door mat 10 may also be used in other applications. For instance, the door mat 10 may be used adjacent to a small step or other obstacles. In that regard, the term “threshold” may be understood to include any raised surface against which the door mat 10 may be positioned. Moreover, aspects of the embodiments described herein may be used with any suitable ramp or inclined surface. Accordingly, the descriptions and illustrations provided herein should not be seen as limiting.

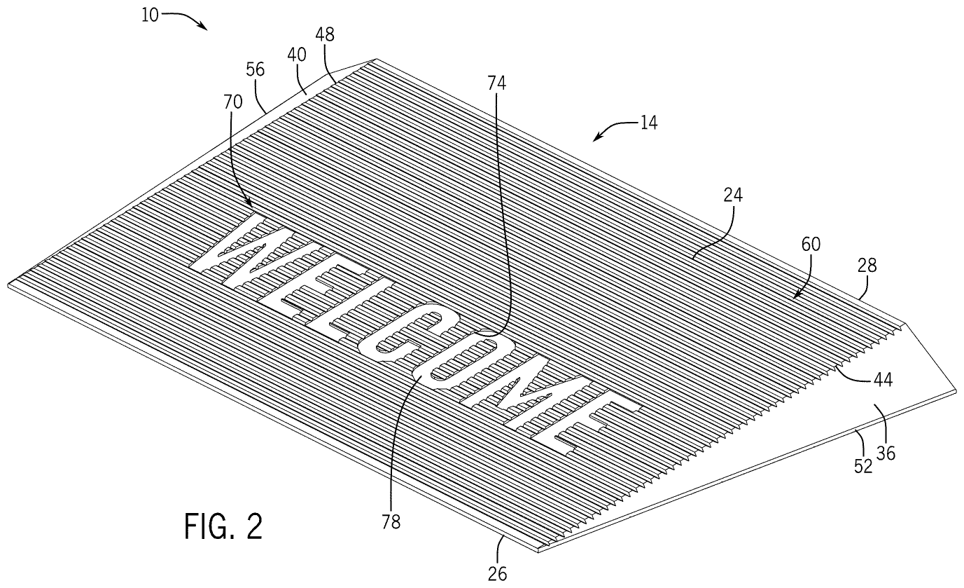

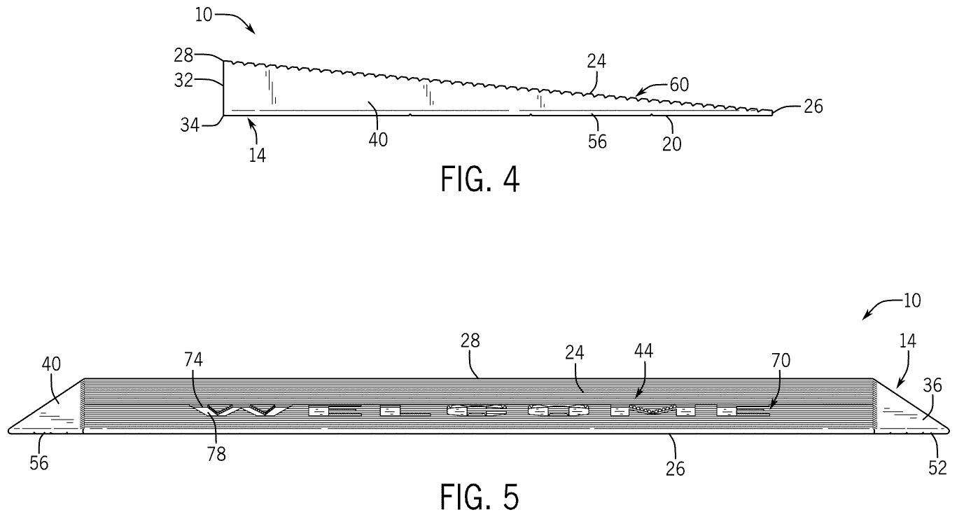

Referring additionally to FIGS. 2-5, the door mat 10 will now be described in detail. In the depicted exemplary embodiment, the door mat 10 includes a body 14 made from a solid piece of rubber or another durable, elastic material. If made of solid rubber, the body 14 is at least somewhat resilient to provide a slight cushioning effect beneath the user. Moreover, if made of rubber or another similar material, the body 14 also provides a substantially non-slip, inclined surface beneath the user. However, the body 14 may instead be made from a stiffer material, such as plastic or metal, and coated with a non-slip and/or cushioning material. If made from a stiffer material, the body 14 may have a hollow interior to minimize its weight.

The body 14 has an overall flared wedge shape defined by a substantially flat, bottom surface 20 and a substantially flat, inclined surface 24 opposite the flat, bottom surface 20. The inclined top surface 24 extends from a front truncated edge 26 of the body 14 where the bottom and top surfaces 20 and 24 meet, and a rear, top edge 28 of the body 14 that is raised relative to the bottom surface 20.

A substantially flat, transverse rear surface 32 extends from the rear, top edge 28 of the body 14 to a rear bottom edge 34. In this manner, the body 14 may be abutted against or otherwise positioned adjacent to a substantially transverse surface (not labeled) extending downwardly from the threshold T. As such, little to no gap is defined between the door mat 10 and the threshold T when in use. In some embodiments, a flange or other type of mating feature may extend from the body 14 to securely connect the door mat 10 to the threshold T or surrounding feature.

The inclined top surface 24 of the body 14 has an incline from the ground G to the threshold T to enable a wheeled mobility device to easily roll across the threshold T and/or to define a gentle slope that may help reduce the risk of tripping and falling when someone shuffles over the threshold. In that regard, the incline of the inclined top surface 24 may conform to standards or regulations for wheelchair ramps. For instance, the incline of the inclined top surface 24 may be designed not to exceed a predetermined maximum value (typically 1:12) set by the Americans with Disabilities Act (ADA) or other regulations.

A first flared side surface 36 extends between a first, top side edge 44 of the body 14 and a corresponding first bottom, truncated edge 52 of the body 14. A second flared side surface 40 defined opposite the first flared side surface 36 extends between a second, top side edge 48 of the body 14 and a corresponding second bottom, truncated edge 56 of the body 14. The flared side surfaces 36 and 40 may each having a transverse slope that conforms to standards or regulations for wheelchair ramps. For instance, the slope of the flared side surfaces 36 and 40 may not exceed a predetermined maximum value (typically 1:10) set by the Americans with Disabilities Act (ADA) or other regulations. As noted above, the body 14 may be made from rubber or another similar high friction material. In this manner, the inclined top surface 24 has suitable non-slip properties to help prevent the user from slipping when traversing over the door mat 10. To further enhance the non-slip properties of the door mat 10, the inclined top surface 24 may also be covered with, treated with, and/or otherwise coated with additional non-slip features, such as ridges, bumps, flocking, tape, textures, etc. For instance, in the depicted exemplary embodiment, the door mat 10 includes a plurality of transverse ridges 60 formed in the inclined top surface 24 and extending across it width (i.e., between the first and second top side edges 44 and 48). The transverse ridges 60 help grip against a user's shoes or feet as they traverse over the door mat 10.

The gradual slope of the door mat 10 enables a wheeled mobility device to easily roll across the threshold and/or helps reduce the risk of tripping and falling when someone shuffles over the threshold. However, if someone is not accustomed to using a door mat with an inclined surface, the door mat 10 may actually increase that person's risk of tripping and falling when traversing over the threshold. In that regard, the door mat 10 is configured to help reduce the risk of tripping and falling for unaccustomed users. In the depicted exemplary embodiment, the door mat 10 includes a visual indicator 70 that provides a warning to a user of the upcoming incline of the door mat 10. In general, the visual indicator 70 has a first visual appearance (i.e., size, shape, orientation, etc.), when viewed from a first orientation or view, and a second visual appearance when viewed from a second orientation or view. For instance, the visual indicator 70 may have an original or substantially undistorted appearance when looking at a top view of the door mat 10 (see

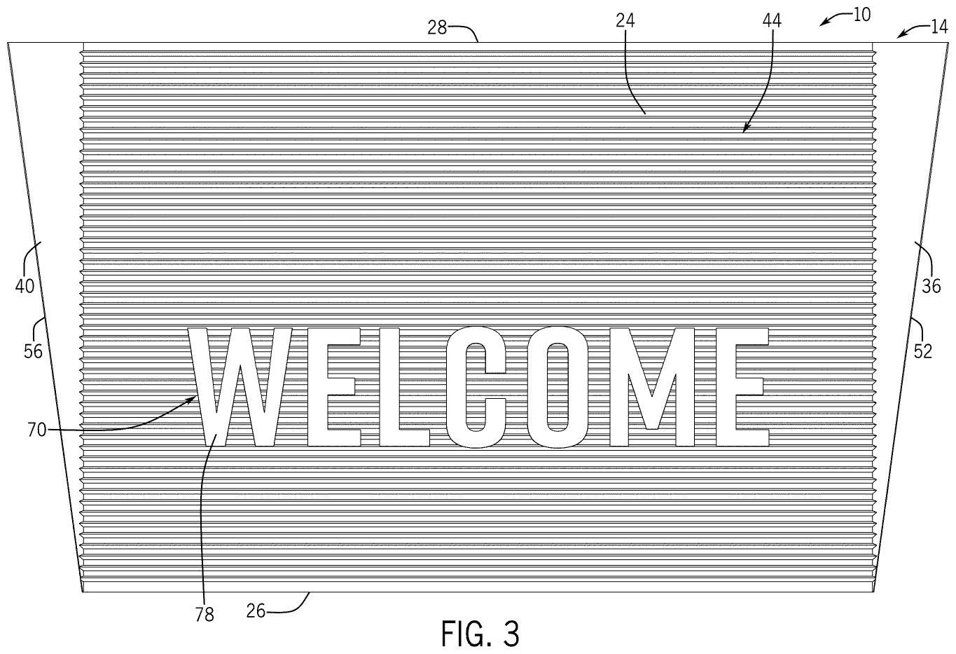

FIG. 3), a first distorted appearance when looking at a front view of the door mat 10 (see FIG. 5), and one or more additional distorted appearances when viewed somewhere between the front view and the top view (such as when approaching the door mat 10).

More specifically, the original appearance may be a typical substantially undistorted appearance of the visual indicator 70, as would be expected by the user when looking substantially straight down at the door mat 10 (i.e., the door mat 10 is viewed substantially from the top, see FIG. 3). The first distorted appearance, on the other hand, may be a shortened appearance that conveys to the user that the visual indicator 70 is at an angle. The visual indicator 70 presents in the distorted appearance to the user when he/she is at a distance from the door mat 10 and/or approaching the door mat 10 (i.e., the door mat 10 is viewed substantially from the front, see FIG. 5). The distorted appearance of the visual indicator 70 indicates to the user that an inclined surface is approaching. In this manner, the user is less likely to trip or otherwise stumble when reaching the door mat 10.

The visual indicator 70 becomes less distorted as the user gets closer to the door mat 10, and the inclined top surface 24 becomes more viewable from substantially the top. Upon reaching the door mat 10, the inclined top surface 24 can be viewed by looking substantially straight down at the door mat, and the visual indicator 70 presents itself to the user in the original, substantially undistorted appearance.

The visual indicator 70 may be any suitable design and configuration that provides a warning to a user of the upcoming incline of the door mat 10 when presented in the distorted appearance. In one exemplary embodiment, the visual indicator 70 is a word that is recognizable to a user that a step, entryway, doorway, etc., is present. For instance, in the depicted exemplary embodiment, the visual indicator 70 is the word “WELCOME”, in all capital letters, defined in or on the inclined top surface 24 of the door mat 10. In that regard, the door mat 10 may be considered to be a welcome mat. Any other word may instead be used, such as “HOME”, “HELLO”, etc. Moreover, it should be appreciated that the visual indicator 70 may instead be a similar word in another language (e.g, “HOLA”, “BIENVENUE”, etc.).

The “WELCOME” visual indicator 70 is defined on or in the inclined top surface 24 in any suitable manner such that it is clearly visible or obvious due to being accentuated in some way. For instance, the “WELCOME” visual indicator 70 may be defined by embossing, carving, molding, forming, or stamping the “WELCOME” design on the inclined top surface 24 of the door mat 10. In a specific example, the “WELCOME” visual indicator 70 is formed on the inclined top surface 24 during an injection molding process.

As can be seen in FIG. 2, the “WELCOME” visual indicator 70 is formed in the transverse ridges 60 on the inclined top surface 24 such that the word “WELCOME” is indented or recessed relative to the transverse ridges 60. Each letter in the word “WELCOME” is defined by an outline wall 74 extending substantially transversely down from the outer or upper surface of the transverse ridges 60 to a flat bottom surface 78 that is substantially transverse to the outline wall 74. In that regard, each letter in the word “WELCOME” has a thickness (e.g., it appears bolded) such that it is clearly visible and legible as formed in the inclined top surface 24/ridges 60. Moreover, the smooth, flat bottom surface 78 contrasts with the texture of the transverse ridges 60 to further highlight the “WELCOME” visual indicator 70 on the door mat 10. It should be appreciated that the bottom surface 78 may also be different color than the transverse ridges 60 to help enhance the contrast between the bottom surface 78 and the transverse ridges 60 (or the inclined top surface 24 if no ridges are used). Moreover, any other differences in texture, smoothness, color, etc., may also be used to highlight the “WELCOME” visual indicator 70 on the door mat 10 and make it more visible to someone approaching the door mat.

When recessed in the door mat 10 in this manner, the “WELCOME” visual indicator 70 is clearly visible and obvious both when viewed substantially from the top (see FIG. 3) and substantially from the front at a distance (see FIG. 5). When viewed substantially from the top (see FIG. 3), the “WELCOME” visual indicator 70 has an original or substantially undistorted appearance. However, when viewed substantially from the front, such as when approaching the door mat 10 at a distance (see FIG. 5), the “WELCOME” visual indicator 70 has a first distorted appearance.

In particular, as can be seen in the front view shown in FIG. 5, each letter in the word “WELCOME” is shorter while having the same width. Such a flattened distortion indicates to the user that an incline exists beneath the “WELCOME” visual indicator 70.

As such, the user can take extra precaution when traversing over the door mat 10.

Thus, it can be appreciated from the foregoing that the door mat 10 helps reduce the risk of tripping for unaccustomed users of an inclined surface.

The recessed visual indicator 70 of the door mat 10 may also help to enhance the non-slip properties of the door mat 10. As can be appreciated, a user's foot or shoe can grip against the recessed visual indicator 70 as the user traverses over the door mat 10. Accordingly, it can be appreciated that the recessed visual indicator 70 can also provide traction benefits.

In an alternative exemplary embodiment, the visual indicator of the door mat may instead be simply painted or printed on the surface of the door mat, and/or the transverse ridges, etc. In such an alternative embodiment, the painted/printed visual indicator would still have an original or substantially undistorted appearance when looking at a top view of the door mat and a first distorted appearance when looking at a front view of the door mat. As such, the painted/printed visual indicator would provide a warning to a user of the upcoming incline of the door mat.

A texturizing material may be added to the painted/printed visual indicator when applied to the door mat to help increase the non-slip properties of the door mat. For instance sand, grit, etc., may be added to the paint or any coating applied to the visual indicator to increase the friction of the surface of the door mat. In this manner, a user's foot or shoe can grip against the higher friction visual indicator as the user traverses over the door mat.

In yet another alternative exemplary embodiment, the visual indicator of the door mat may instead be inlaid into the door mat body or an inclined floor surface. Similar to the painted/printed visual indicator embodiment, the inlaid visual indicator would have an original or substantially undistorted appearance when looking at a top view of the door mat and a first distorted appearance when looking at a front view of the door mat. As such, the inlaid visual indicator would provide a warning to a user of the upcoming incline of the door mat.

Moreover, the inlaid visual indicator may be defined by a high friction material to help increase the non-slip properties of the door mat. For instance the inlaid visual indicator may be defined by rubber or the like. In this manner, a user's foot or shoe can grip against the higher friction visual indicator as the user traverses over the door mat.

Thus it can be appreciated that any suitable visual indicator having an original or substantially undistorted appearance when looking at a top view of the door mat and a first distorted appearance when looking at a front view of the door mat is within the scope of the present disclosure.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “top surface”, “bottom surface”, “vertical”, “horizontal”, etc., in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features. While illustrative embodiments have been illustrated and described, it will be appreciated that various changes can be made therein without departing from the spirit and scope of the disclosure.

The embodiments of the disclosure in which an exclusive property or privilege is claimed are defined as follows:

1. A door mat, comprising:
a body having an inclined top surface; and
a visual indicator defined in the inclined top surface having a first visual appearance from a first view of the door mat and a second visual appearance from a second view of the door mat.

2. The door mat of claim 1, wherein the first view is a top view and the second view is a front view.

3. The door mat of claim 1, wherein the first visual appearance of the visual indicator is an original appearance, and the second visual appearance of the visual indicator is a distorted appearance.

4. The door mat of claim 1, wherein the first visual appearance of the visual indicator is an original appearance, and the second visual appearance of the visual indicator is a shortened appearance.

5. The door mat of claim 3, wherein the visual indicator is a word indicative of at least one of a step, an entryway, a doorway, or any combination thereof

6. The door mat of claim 1, wherein the visual indicator is defined by at least one outline wall extending downwardly from the inclined top surface and a bottom surface extending substantially transverse to the at least one outline wall.

7. The door mat of claim 1, wherein the visual indicator is recessed in the inclined top surface.

8. The door mat of claim 1, wherein the visual indicator has a first color and the inclined top surface has a second color different than the first color.

9. A door mat, comprising:
a body having an inclined top surface; and
a visual indicator defined in the inclined top surface having an original visual appearance from a top view of the door mat and a distorted visual appearance from a front view of the door mat.

10. The door mat of claim 9, wherein the visual indicator has a first color and the inclined top surface has a second color different than the first color.

11. The door mat of claim 9, wherein the distorted visual appearance of the visual indicator is a shortened appearance.

12. The door mat of claim 9, wherein the visual indicator has a first color and the inclined top surface has a second color different than the first color.

13. A door mat, comprising:
a body having an inclined top surface; and
a visual indicator defined on the inclined top surface having a first visual appearance from a first view of the door mat and a second visual appearance from a second view of the door mat.

14. The door mat of claim 13, wherein the first view is a top view and the second view is a front view.

15. The door mat of claim 13, wherein the first visual appearance of the visual indicator is an original appearance, and the second visual appearance of the visual indicator is a distorted appearance.

16. The door mat of claim 13, wherein the first visual appearance of the visual indicator is an original appearance, and the second visual appearance of the visual indicator is a shortened appearance.

17. The door mat of claim 13, wherein the visual indicator is defined by at least one outline wall extending downwardly from the inclined top surface and a bottom surface extending substantially transverse to the at least one outline wall.

18. The door mat of claim 13, wherein the visual indicator is recessed in the inclined top surface.

19. The door mat of claim 1, wherein the visual indicator is painted or printed on the inclined top surface.

20. The door mat of claim 1, wherein the visual indicator is inlaid in the inclined top surface.
